(19) United States
(12) Patent Application Publication
(10) Pub. No.: US 2006/0137410 A1
(43) Pub. Date: Jun. 29, 2006

(54) Secure product keeper case

(76) Inventors: King Yeung Choi, Hong Kong (CN); Kwok Keung Kwong, Hong Kong (CN)

Correspondence Address: ALIX YALE & RISTAS LLP, 750 MAIN STREET, SUITE 1400, HARTFORD, CT, 06103, US

(21) Appl. No.: 11/023,885

(22) Filed: Dec. 28, 2004

(51) Int. Cl. E05B 73/00

(52) U.S. Cl. 70/57.1

(57) ABSTRACT

A keeper case includes an elongate latch which in an unlocked position is restrained against longitudinal movement and has a surface for engagement by a mechanical key to deflect laterally to enable longitudinal displacement of the latch toward a locked position. An insert is located within the latch for magnetic interaction with an external unlocking device, and there is an aperture in the case through which a mechanical key can be inserted for engagement with the latch to cause movement thereof to its locked position.

### BACKGROUND OF THE INVENTION

The present invention relates to keeper cases for securely containing and displaying items for sale or hire in retail outlets or rental houses. The invention more particularly relates to a secure keeper case for displaying packaged DVD movies and the like in such outlets.

It is known to display DVD take-home packages and the like within see-through plastics keeper cases from which the take-home packaging is removed by the cashier at the point of sale. The keeper cases are then reused, as the shelves are restocked with new DVD packages using them. Such keeper cases are locked and unlocked by sliding an edge of the case through a special bench counter-mounted unlocking device that produces a magnetic field across the edge of the case.

A problem associated with such known keeper cases is that the same special unlocking device is used both by the cashier to unlock the keeper case and by trusted personnel in the shop's store room or warehouse to lock the keeper cases after new or returned take-home packages are inserted into them. As many untrusted people such as delivery couriers and cleaners for example come and go from the store room or warehouse, there exists a problem of theft of the valuable DVDs from within the keeper cases as they are readily unlocked with the special unlocking device that must be present in the store room or warehouse for legitimate use.

### OBJECT OF THE INVENTION

It is the object of the present invention to overcome or substantially ameliorate the above problem and/or more generally to provide an improved keeper case including a locking mechanism by which a mechanical key can be used to lock the keeper case, but cannot be used to unlock the keeper case, and in which the case can be unlocked only by separate magnetic means.

Typically, a shop's store room or warehouse personnel would have access to the mechanical locking key, but only the cashier would have access to the magnetic unlocking means.

### DISCLOSURE OF THE INVENTION

There is disclosed herein a keeper case, comprising:
a first housing component,
a second housing component hingedly attached to the first housing component and closing against the first housing component to define a cavity within which an item can be secured for display purposes,
a mechanical locking mechanism located at an edge region of the first housing component and including an elongate latch which in an unlocked position is restrained against longitudinal movement within the edge region of the first housing component and has a bearing surface for engagement by a mechanical key to deflect laterally to enable longitudinal displacement of the latch toward a locked position in which the edge of the first housing component is locked closed to the second housing component,
an aperture in the first and/or second housing components through which the mechanical key can be inserted for engagement with the bearing surface of the latch, and
an insert attached to or located within the latch for magnetic interaction with an external unlocking device to cause movement of the latch from its locked position.

Preferably, the insert comprises ferrous metal.

Preferably, the latch comprises a first resilient member including an angled ramp surface against which the key bears to cause said lateral displacement.

Preferably, the edge of the first housing component includes a first catch against which the latch engages in its unlocked position to prevent longitudinal movement thereof until the first resilient member is deflected laterally by the key.

Preferably, the keeper case further comprises a second catch against which a second resilient member of the latch engages when in a locked position to prevent longitudinal movement thereof.

Preferably, the keeper case further comprises a ferrous metal insert attached to or located within the second resilient member of the latch to enable lateral movement of the second member to clear the second catch to enabling longitudinal movement of the latch away from the locked position upon magnetic interaction with a magnetic field produced by an unlocking device.

There is further disclosed herein a combination comprising the keeper case as disclosed above, and a mechanical key having an angled tip for engagement against the latch to cause lateral displacement thereof.

There is still further disclosed herein a combination comprising the keeper case as disclosed above, and a magnetic unlocking device comprising a guide through or past which mutually interlocked edge regions of the first and second housing components are swept, and comprising a magnet configured with respect to the guide to attract the ferrous metal insert to cause lateral movement of the second member of the latch and longitudinal movement of the latch away from the locked position.

### BRIEF DESCRIPTION OF THE DRAWINGS

A preferred form of the present invention will now be described by way of example with reference to the accompanying drawings, wherein:

FIG. 1 is a schematic perspective illustration of a keeper case in a closed configuration,

FIG. 2 is a schematic cross-sectional elevation of engaged edge regions of the keeper case of FIG. 1,

FIG. 3 is a schematic perspective illustration of the keeper case of FIG. 1 in an open configuration,

FIG. 4 is a schematic perspective illustration of the keeper case of FIG. 1 in a partly open configuration,

FIG. 5 is a schematic perspective illustration of the keeper case of FIG. 1 in a closed configuration,

FIGS. 6 to 10 are schematic cross-sectional elevations of the engaged edge regions of the keeper case of FIG. 1 including an internal latch and its interaction with a mechanical key used to lock the keeper Case closed,

FIGS. 11 and 12 are a schematic elevations of the mechanical locking key,

FIGS. 12 and 13 are schematic perspective illustrations of the mechanical locking key,

FIGS. 15 to 17 are schematic perspective illustrations of the keeper case interacting with the mechanical locking key,

FIG. 18 is a schematic cross-sectional elevation of the narrow edge portions of the keeper case with the latch in an unlocked position, and

FIG. 19 is a schematic cross-sectional elevation of the narrow edge portions of the keeper case with the latch in a locked position.

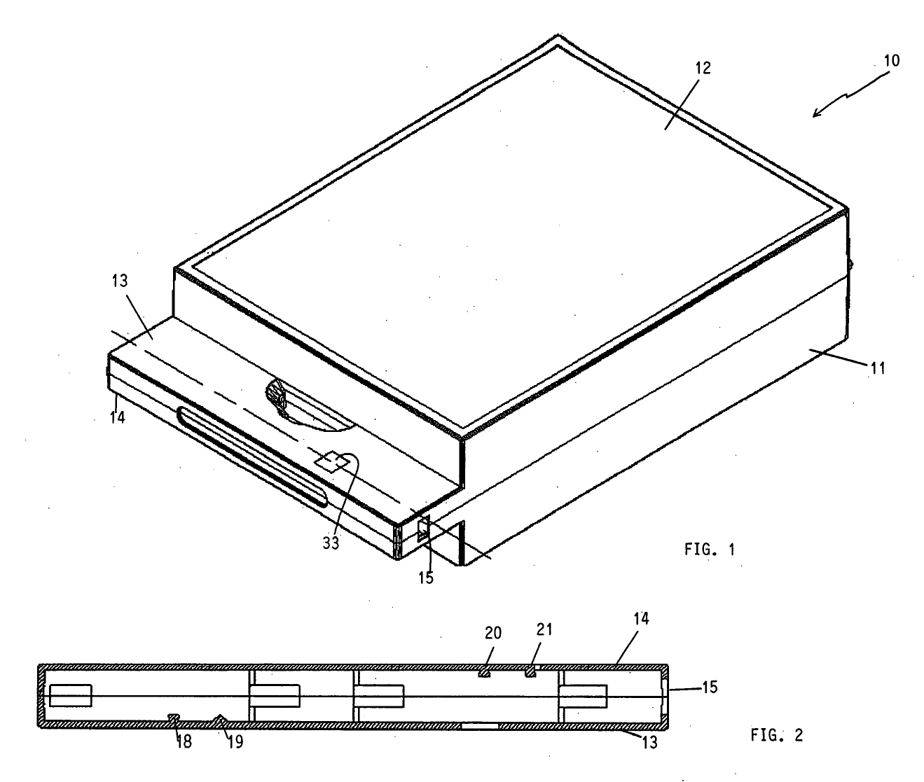

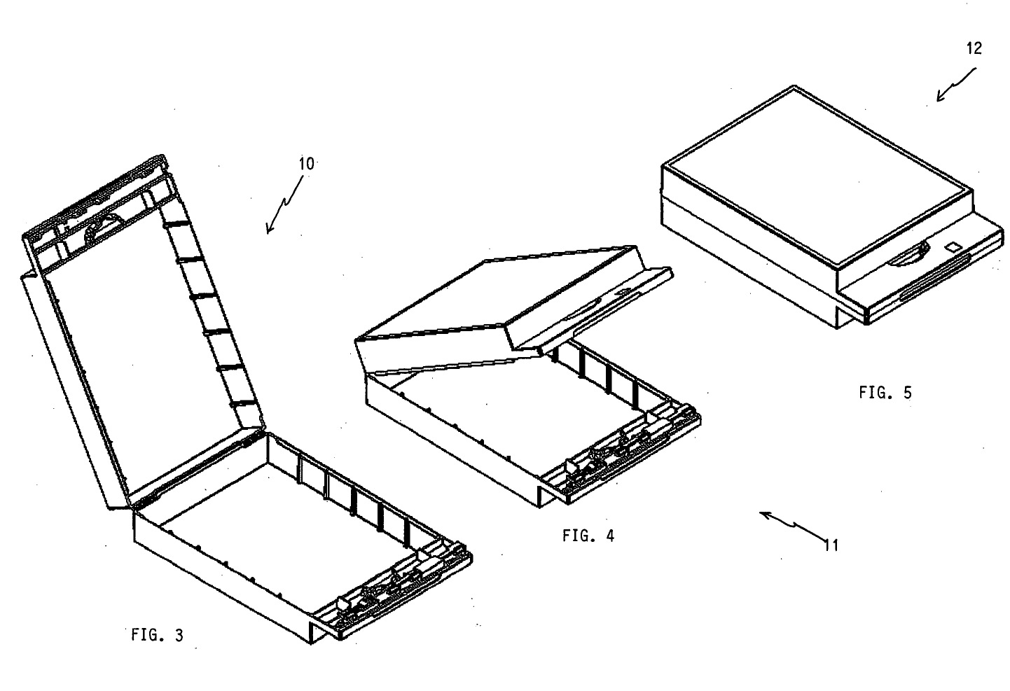

### DESCRIPTION OF THE PREFERRED EMBODIMENT

In the accompanying drawings there is depicted schematically a keeper case 10 for securely locating one or more DVD packages therein for display on the shelf in a store. The keeper case 10 is typically made of strong see-through plastics material and includes a first component 11 and the second component 12 hingedly connected to one another at a spine.

Opposite the spine, the first and second components comprise narrow edge portions 13 and 14 respectively. Within these edge portions there is a locking mechanism to be described. There is an aperture 15 at one end of the narrow portions 13 and 14 through which a mechanical locking key can be inserted.

There is a locked or unlocked status viewing window 33 on the upper surface of the narrow portion 14 through which a bright coloured marking of the internal latch 22 can be seen—depending upon its position.

Inside the narrow portions 13 and 14 as depicted in FIG. 2, the first member 13 includes a catch 18 of substantially square, or slightly outwardly tapered cross-sectional shape alongside a notch 19 of substantially triangular convergent cross-sectional shape. The second member 14 includes a catch 20 similar to catch 18 and a notch 21 of substantially square cross-sectional shape.

Located between the narrow portions 13 and 14 is an elongate latch 22 which moves longitudinally between locking and unlocking positions in a manner to be described. At the first end of the latch 22, there is a first resilient member 23. At the other end of the latch 22, there is a second resilient member 24. Each resilient member has a hollow 25 to receive a small piece of ferrous metal.

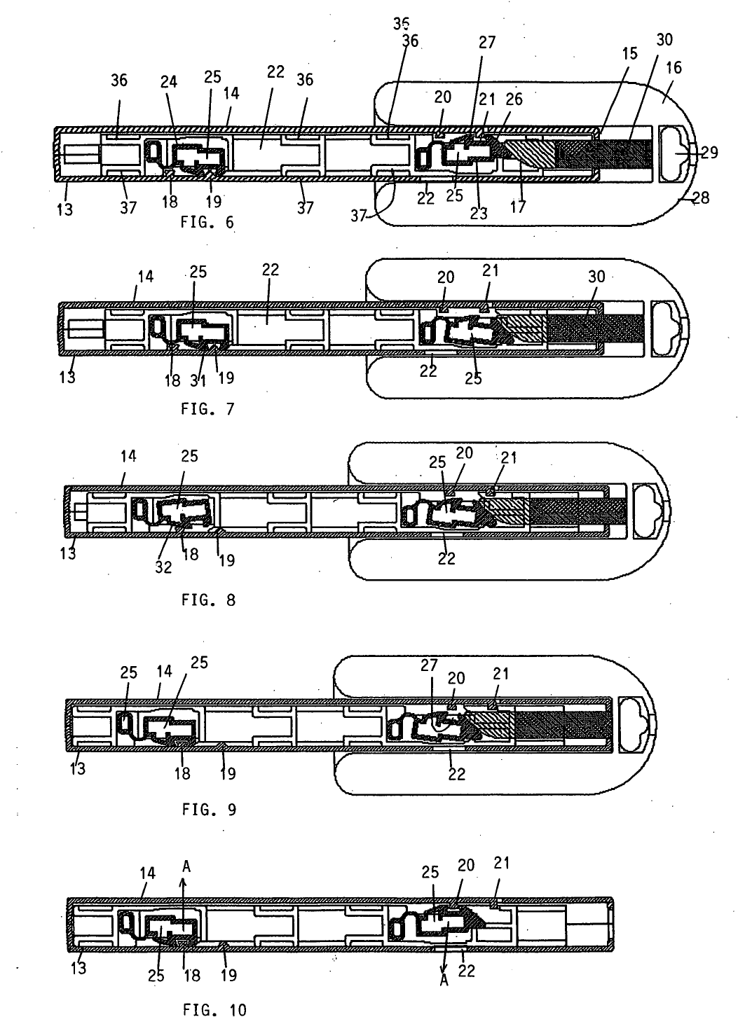

The first resilient member 23 includes a ramp surface 26 and a cavity 27 into which the catch 21 is received in order to maintain the latch 22 in its unlocked position as shown in FIG. 6.

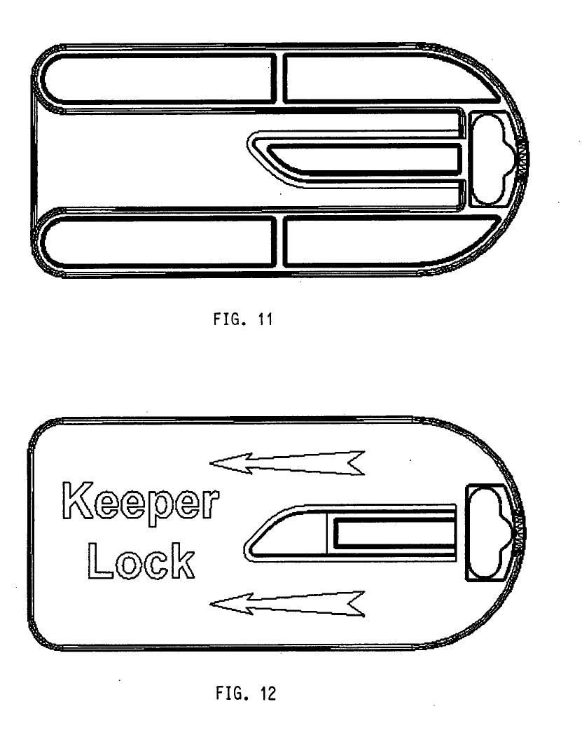

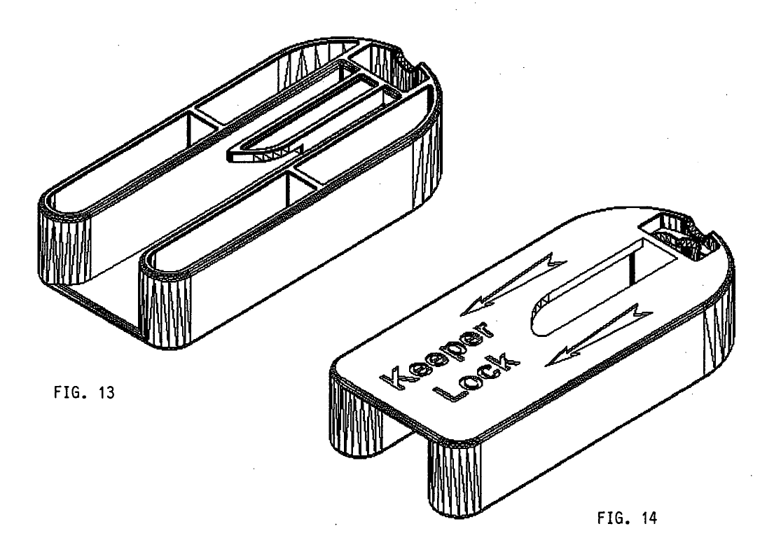

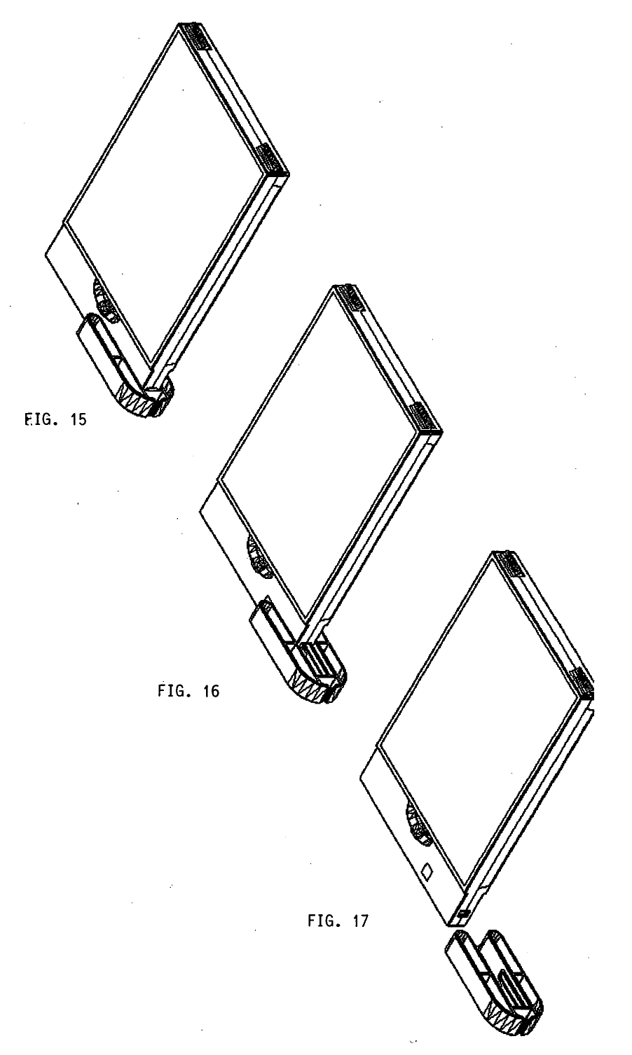

A mechanical key 16 which is shown in FIGS. 6 to 9 and in FIGS. 11 to 13 includes a body 28 having an aperture 29 by which the key might be suspended from a wall nail for example. The key 16 also includes an elongate tongue 30 having an angled tip 17 for engagement against the ramp surface 26 of the first resilient member 23 when inserted through the aperture 15. The tongue 30 resides within a slot or other guide within the body 28 that is sized to receive the locked-together narrow end portions 13 and 14 of the closed keeper case.

As shown in FIG. 7, engagement of the angled tip 17 with the ramp surface 26 causes lateral deflection of the resilient member 23 to dissociate the cavity 27 from the catch 21.

The second resilient member 24 includes its own cavity 31 that fits over the triangular notch 19. Upon movement of the latch 22 to the left, the second resilient member 24 rides over the notch 19 to lift an inclined surface 32 of the second resilient member onto the catch 18 as shown in FIG. 8. Further movement of the latch to the left aligns the cavity 31 of the second resilient member with the catch 18 so that the second resilience of member 24 snaps the cavity 31 into place upon the catch 18 thereby locking the latch in the left position.

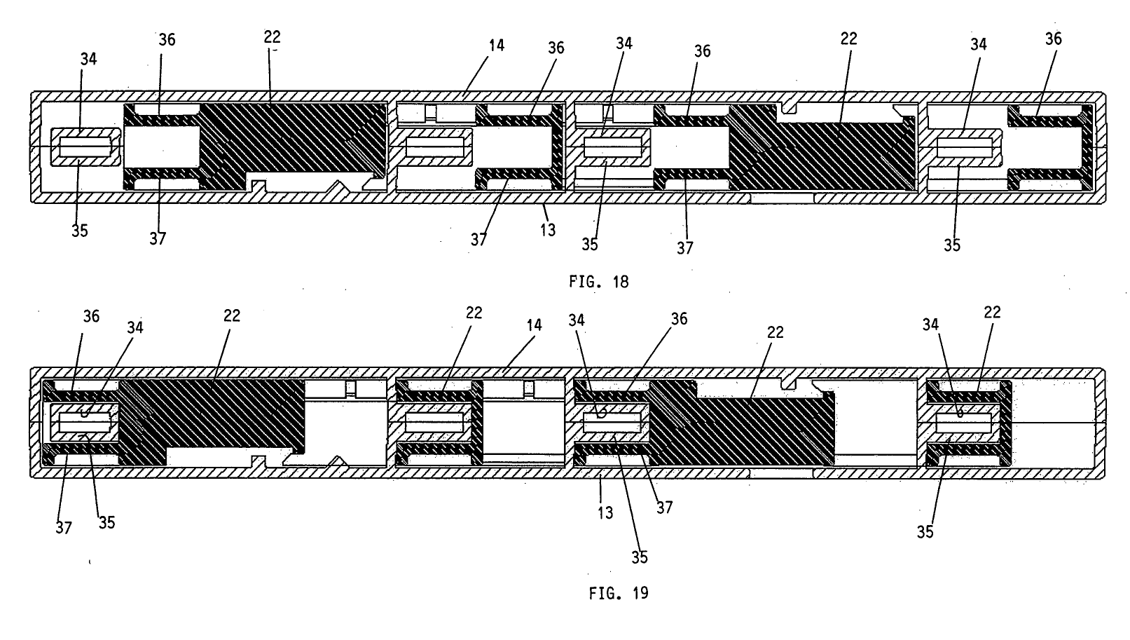

The latch 22 includes first clamping arms 36 and opposed second clamping arms 37, whereas there is formed integrally with each narrow portion 14 and 13 a corresponding number of clamping bars 34 and 35. See FIGS. 18 and 19. In the unlocked position of the latch 22, the clamping arms 36 and 37 are away from the clamping bars 34 and 35 so that the narrow portions can be moved away from one another to enable opening of the keeper case. In the locked position of the latch 22, the clamping arms 36 and 37 surround the clamping bars 34 and 35 and therefore the narrow portions 14 and 13 cannot be separated. Ie the keeper case is locked closed.

Upon removal of the tongue 30 from the aperture 15, the first resilient member moves to the position depicted in FIG. 10 whereupon its cavity 27 moves upwardly to receive the catch 20.

The cavities 27 and 31 are tapered to match the tapered profiles of the catches 18 and 20 and cannot be lifted away therefrom unless a magnetic field is applied to draw the ferrous metal inserts 25 laterally away from the respective catches as shown by arrows A in FIG. 10 this is achieved by passing the locked together narrow portions 13 and 14 through a slot of a magnetic unlocking device kept only at the cashier's counter.

It should be appreciated that modifications and alterations obvious to those skilled in the art are not to be considered as beyond the scope of the present invention. For example, only one of the tip of the mechanical locking key's tongue or the surface 26 of the first resilient member need be angled or sloped like a ramp. It would suffice that any interaction upon linear displacement of the tongue through the aperture 15 between the tongue and the resilient member effects lateral movement of the resilient member.

1. A keeper case, comprising:
a first housing component,
a second housing component hingedly attached to the first housing component and closing against the first housing component to define a cavity within which an item can be secured for display purposes,
a mechanical locking mechanism located at an edge region of the first housing component and including an elongate latch which in an unlocked position is restrained against longitudinal movement within the edge region of the first housing component and has a bearing surface for engagement by a mechanical key to deflect laterally to enable longitudinal displacement of the latch toward a locked position in which the edge of the first housing component is locked closed to the second housing component,
an aperture in the first and/or second housing components through which the mechanical key can be inserted for engagement with the bearing surface of the latch, and an insert attached to or located within the latch for magnetic interaction with an external unlocking device to cause movement of the latch from its locked position.

2. The keeper case of claim 1, wherein the insert comprises ferrous metal.

3. The keeper case of claim 1, wherein the latch comprises a first resilient member including an angled ramp surface against which the key bears to cause said lateral displacement.

4. The keeper case of claim 3, wherein the edge of the first housing component includes a first catch against which the latch engages in its unlocked position to prevent longitudinal movement thereof until the first resilient member is deflected laterally by the key.

5. The keeper case of claim 4, further comprising a second catch against which the a second resilient member of the latch engages when in a locked position to prevent longitudinal movement thereof.

6. The keeper case of claim 5, further comprising a ferrous metal insert attached to or located within the second resilient member of the latch to enable lateral movement of the second member to clear the second catch to enabling longitudinal movement of the latch away from the locked position upon magnetic interaction with a magnetic field produced by an unlocking device.

7. In combination with the keeper case of claim 1, a mechanical key having an angled tip for engagement against the latch to cause lateral displacement thereof.

8. In combination with the keeper case of claim 6, a magnetic unlocking device comprising a guide through or past which mutually interlocked edge regions of the first and second housing components are swept, and comprising a magnet configured with respect to the guide to attract the ferrous metal insert to cause lateral movement of the second member of the latch and longitudinal movement of the latch away from the locked position.

9. In combination with the keeper case of claim 2, a mechanical key having an angled tip for engagement against the latch to cause lateral displacement thereof.

10. In combination with the keeper case of claim 3, a mechanical key having an angled tip for engagement against the latch to cause lateral displacement thereof.

11. In combination with the keeper case of claim 4, a mechanical key having an angled tip for engagement against the latch to cause lateral displacement thereof.

12. In combination with the keeper case of claim 5, a mechanical key having an angled tip for engagement against the latch to cause lateral displacement thereof.

13. In combination with the keeper case of claim 6, a mechanical key having an angled tip for engagement against the latch to cause lateral displacement thereof.
